(19) United States
(12) Patent Application Publication
(10) Pub. No.: US 2009/0242327 A1
(43) Pub. Date: Oct. 1, 2009

(54) LADDER SAFETY DOCK

(76) Inventor: William Tracy, Springtown, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/059,382

(22) Filed: Mar. 31, 2008

(51) Int. Cl. E06C 7/48

(52) U.S. Cl. 182/107

(57) ABSTRACT

A safety device is shown for use with a ladder which is leaned against the upper part of a structural wall of a building that is equipped with a rain gutter under the eaves. The device is closely received within the interior of the existing rain gutter and secured to the fascia board of the wall. The device has exposed, spaced ears which allow the ladder to be docked safely and an elastic tie-down cord to further secure the ladder in position. Otherwise, the device is not readily apparent to an observer and provides increased ladder safety while also serving to protect the gutter against deformation when the ladder is put in place.

### BACKGROUND OF THE INVENTION

1. Field of the Invention

The present invention generally relates to an improved device for supporting a ladder against the roof and wall of a building structure where the building structure has a roof line equipped with a gutter under the eaves thereof.

2. Description of the Prior Art

Most houses built in the United States today include gutters which are secured to either the rafter or to the fascia board of the house structure, just below the roof line. These gutters assist in protecting the siding or paint of the house, as well as the foundation, by catching the rain, snow and the like and causing it to flow to down spouts and away from the house structures with minimal contact with the house structures. The construction of gutters and the various placement techniques used in the industry today are well known the relevant arts. Today's typical gutters are generally made of a thin sheet of aluminum, vinyl, or plastic so as to be light in weight. However, the presence of thin aluminum or plastic gutters along the fascia board of a structure can be problematical when one needs to access the roof or upper portion of the building structure.

Whenever it becomes necessary to reach the roof of a building structure, such as a house, the usual procedure is to place a ladder in position against the wall or an eave of the roof. If a rain gutter is in place below the eave, the ladder is usually placed against the gutter. Because of the relative weakness of the construction of a gutter, the weight of the ladder and of the person ascending such ladder creates a risk of damaging the gutter. The thin gutters of modern construction cannot withstand much pressure before bending. When a ladder is placed against the front of a gutter it will tend to crush the gutter and slide along it. This often results in a structure's gutter having to be replaced. Further, because the relatively narrow surfaces of the rails of the ladder rest against the relatively narrow, horizontally extending surface of the outer edge of the gutter, the person ascending the ladder faces the risk of ladder slippage and a consequently serious fall. Falls from ladders of this type are a common source of serious injury in the United States each year.

This risk is compounded in a variety of circumstances where the ground or surface on which the ladder is used is sloped or uneven. This in itself makes the ladder prone to movement when a person stands on any of the higher rungs of the ladder, especially if the ground is soft or otherwise less stable than expected. As has been mentioned, although some surfaces against which a ladder can be placed do provide a degree of frictional contact to prevent sideways slippage, the ladder-to-gutter contact is often a relatively slippery one, with metal-to-metal or metal-to-plastic contact being the norm.

In any event, even when used on stable level ground there is still an inherent risk of the ladder sliding sideways when it is leaned against a gutter, especially in situations where there might be sudden weight transference or over-reaching by the person concerned. Even the very mode of gaining access to the roof area means the ladder may be moved sideways as the user takes his weight off the ladder and steps onto the roof, or much more dangerously steps from the roof onto the ladder, which might unexpectedly move away.

A wide range of devices and methods have been proposed in the prior art for solving the above described problems. For example, U.S. Pat. No. 4,601,365 shows a gutter ladder support in the form of a brace bar arrangement which is fitted within the upward opening of the gutter.

U.S. Pat. No. 4,813,515 shows another type of gutter guard device which includes a pair of ears carried by the frame for placement of a ladder.

U.S. Pat. No. 5,971,100 shows a gutter saver and ladder mount which fits within the upward opening of a gutter and which includes external ears which are spaced by a distance greater than or equal to the width of the ladder.

U.S. Pat. No. 6,691,829 shows a gutter guard for use with a ladder which is leaned against the upper part of a structural wall of a dwelling. This device is secured to the fascia board of the wall and includes spurs or ears to prevent slippage of a ladder. The device appears to be in the nature of a type of bracket.

U.S. Pat. No. 7,093,689 shows a ladder support bracket which fits over the upwardly extending opening of the gutter and is affixed to the battens or rafters by screws (column 4, lines 23-27). The device also appears to feature a type of turnover lip (14 in FIG. 2).

U.S. Pat. No. 5,509,500 shows a device having an anti-slip portion (22 in FIG. 2) which fits within the contours of the gutter interior. The device also has the external ears 36, 27 to prevent ladder slippage.

U.S. Pat. No. 6,354,401 shows a gutter saver and ladder support in the form of a U-shaped channel member which fits over the lip of a gutter and which includes a bungee cord type strap (51 in FIGS. 2 and 3) for securing the ladder.

Finally, U.S. Pat. No. 4,272,370 shows a gutter strainer design which includes a wire mesh grate at either end of the device.

Certain of the above designs were overly complicated for the task at hand and were consequently prohibitively expensive to manufacture. Other of the designs had as their primary goal to prevent damage to the gutter but were less than satisfactory as safety devices to prevent the ladder from slipping. Other designs performed both functions to one extent or another, but were obtrusive in appearance and detracted from the aesthetic appearance of the building structure if left in place for future use.

Thus, despite the above advances in the art, it would be advantageous to provide a simple means of providing a safe way to prevent the ladder from moving sideways along the gutter in such situations, which is itself relatively easy to use and which is economical to produce and which also serves to protect the gutter from damage in use.

### SUMMARY OF THE INVENTION

It is an object of the present invention to provide a ladder safety dock which can be attached to the rafters or fascia board of the roof line of a building structure at a level substantially even with the plane of the upper edge of the gutter, whereby the ladder safety dock is relatively unobtrusive and yet which securely prevents the ladder from sliding along the edge of the gutter while protecting the gutter from damage.

It is another object of the invention to provide such a device which utilizes a pair of spaced retaining ears which provide a positive stop to prevent sideways slippage of the ladder when it is in place on the dock.

It is a further object of the invention to provide such a device with additional features which also prevent the ladder from inadvertently falling backwards away from the building while its occupant is in position on the ladder or ascending or descending the roof area.

Another object of the invention is to provide such a ladder safety dock which acts as a ladder dock locating means for marking the spot or spots which have been designated for safe access to the roof.

In accordance with the above objectives, the ladder safety dock of the invention is used for supporting a ladder on a fascia board or rafters of the roof line of a building structure having a gutter where the gutter has a back sidewall adapted to be fastened to the fascia board or rafters, an opposing front side with a front sidewall lip, a bottom wall, and an open top. The ladder safety dock is made up of a dock body installable within the gutter in a longitudinal plane substantially adjacent the open top of said gutter. The dock body has a front sidewall of a given length, a rear sidewall and opposing end walls. The dock body also has a pair of oppositely arranged retaining ears extending outwardly at either of two opposite extents thereof, the retaining ears being spaced apart a predetermined distance to allow a ladder to be received there between to thereby prevent the ladder from sliding along the gutter in sidewise fashion.

The front sidewall of the safety dock body terminates in a curved lip portion which extends substantially the length of the front sidewall and which is sized to curve around and over the gutter front lip to help to secure the dock body in place within the gutter while also presenting a pleasing esthetic profile as viewed from the front side of the gutter.

The oppositely arranged retaining ears are preferably formed as an extension of the dock body opposing end walls so that the retaining ears lie in a common plane with the dock body end walls. The preferred retaining ears are planar flaps, each having an opening formed therein for receiving a safety line for securing a ladder in position between the safety ears to keep a user from falling backwards away from the building wall. In one preferred form of the invention, the safety line is a bungee cord formed of a length of elastic material and having hooks at either of two ends thereof.

A grated opening can also be provided in each of the two opposing end walls of the safety dock body, the grated opening being sized to allow fluids to flow but to arrest the movement of leaves, trash and other debris.

In the preferred form, a plurality of holes are pre-drilled in the rear sidewall of the safety dock body to accommodate attachment elements for securing the safety dock body to the rear sidewall and, in turn, the gutter and fascia board or rafter of the building structure.

The ladder safety dock body sidewalls and end walls are of a predetermined height which is selected to allow the safety dock to fit within the gutter in flush fashion without protruding significantly upward above the gutter, whereby the safety dock curved lip and retaining ears are the only portions of the safety dock readily visible by an observer on the ground when the ladder safety dock is in place in the gutter.

These and other aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a view of a prior art gutter which has been installed on the fascia board of a building structure showing the top portion of a ladder which has been placed against the gutter, causing the gutter to bend.

FIG. 2 is an isolated, perspective view of the ladder safety dock of the invention.

FIG. 3 is a perspective view of the ladder dock of FIG. 2 installed within the gutter of a building structure and showing the placement of the top portion of a ladder between the retaining ears thereof.

FIG. 4 is a side view of the ladder safety dock of the invention installed within a gutter with a portion of the gutter broken away for ease of illustration.

FIG. 5 is a top view of the gutter with the ladder safety dock of the invention in place.

FIG. 6 is a view of a portion of a bungee cord of the type which can be used with the ladder dock of the invention.

### DETAILED DESCRIPTION OF THE INVENTION

The embodiments described herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments described herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

The description of the invention which follows uses the term “ladder” safety dock. Although the following description refers to “ladders” generally, no limitation is intended thereby. Any related device including, but not necessarily limited to, step ladders, fixed length ladders, extension ladders, trestles, work platforms or scaffolding, requiring a ladder like element to be placed against a building wall roof line and gutter, is also contemplated. Again, although the following description refers primarily to conventional houses or buildings having a gutter mounted on a conventional fascia, no such limitation is intended, and any analogous use of a ladder leaned against a gutter or otherwise is meant to be included, whereby suitable adaptation the invention may be so employed.

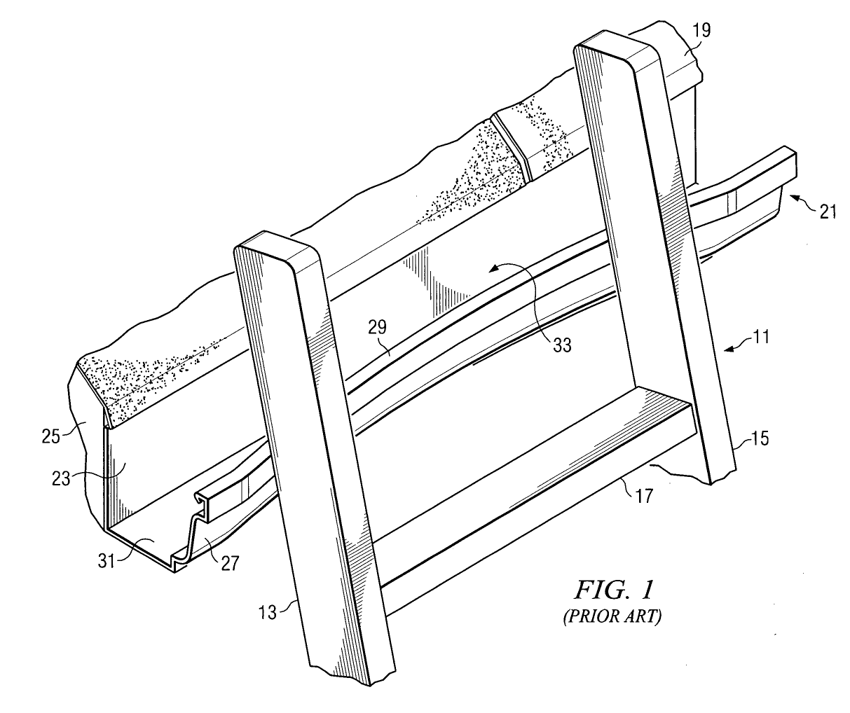

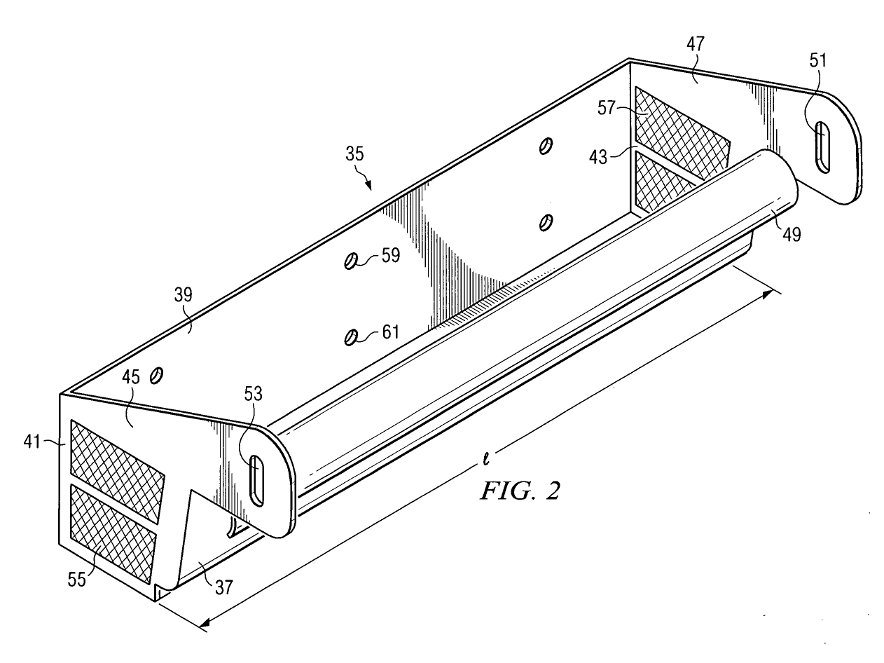

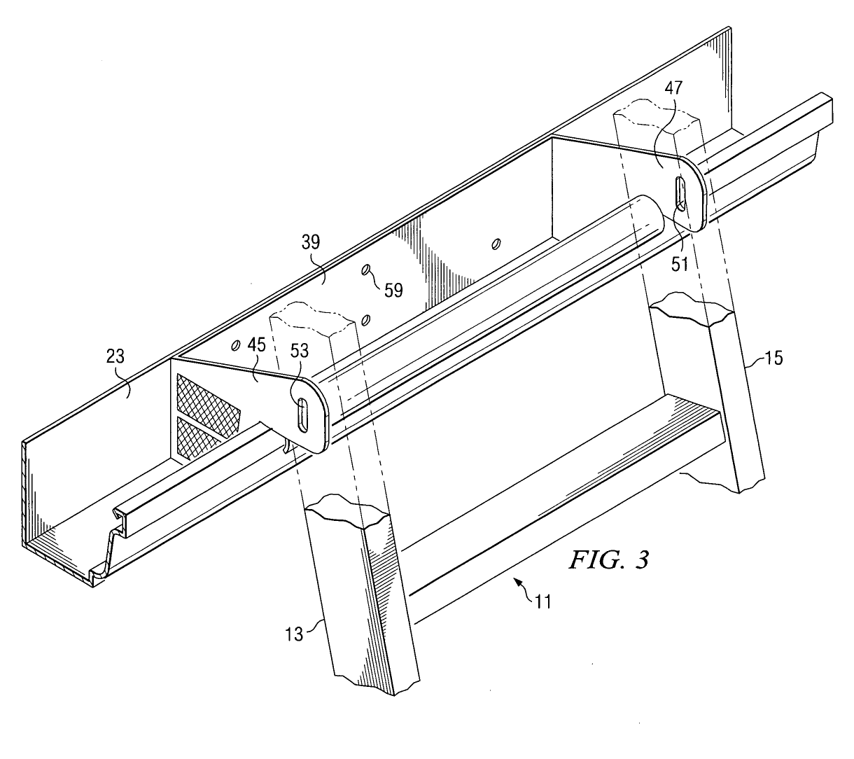

Turning to FIG. 1, there is shown a view of a prior art ladder 11 having upright rails 13, 15 and intermediate rungs or steps 17. The ladder 11 is resting against a portion of the roof of a building structure 19 having a gutter 21 mounted thereon. As will be appreciated from FIG. 1, the gutter 21 is of conventional design having a back sidewall 23 which is adapted to be fastened to the fascia board 25 (or rafters) of the building roof line. The gutter 21 also has an opposing front sidewall 27 with a front sidewall lip 29, a bottom wall 31 and an open top which creates an interior space 33. The gutter 21 is a conventional design and will be well familiar to those skilled in the relevant arts. Turning to FIG. 2, there is shown a ladder safety dock 35 of the invention which is installable within the gutter 21 in a longitudinal plane (see FIG. 3) substantially adjacent or flush with the open top of the gutter 21. As will be appreciated from FIG. 2, the dock body has a front sidewall 37 of a given length (“1” in FIG. 2). The dock body also has a rear sidewall 39 and opposing end walls 41, 43. The dock body has a pair of oppositely arranged retaining ears 45, 47 which extend outwardly at either of two opposite extents thereof. The retaining ears 45, 47 are spaced apart by a predetermined distance (basically the distance “1” in FIG. 2). The spacing of the ears 45, 47 is selected to allow a ladder 11 to be received there between to thereby prevent the ladder from sliding along the gutter 21 in sidewise fashion.

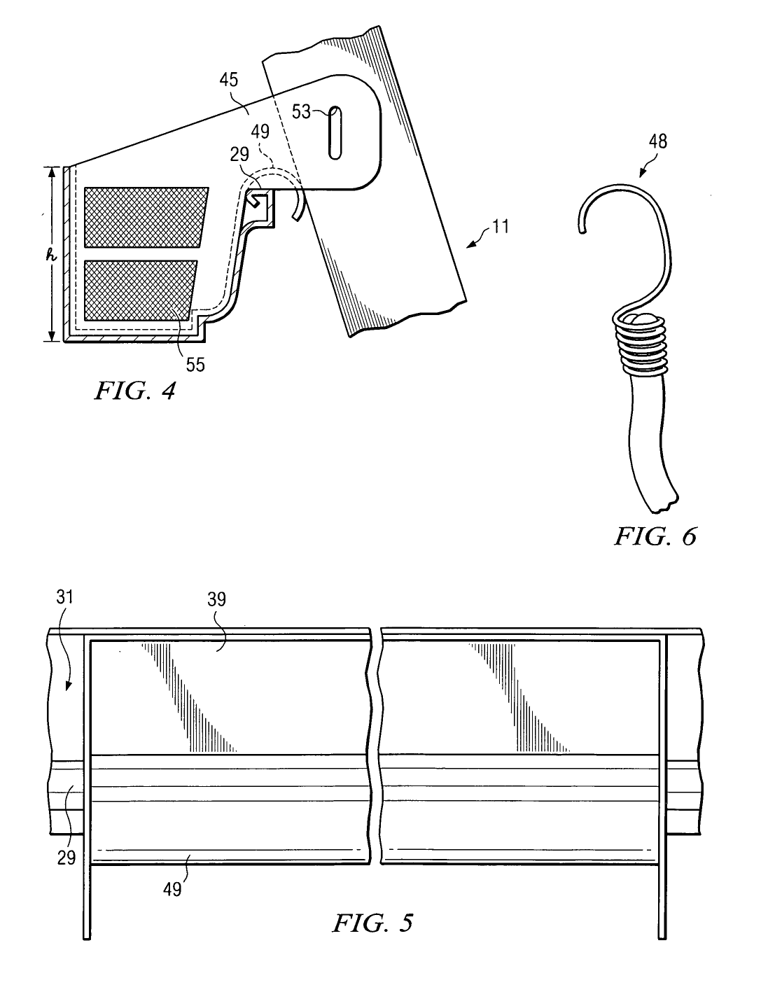

As also will be appreciated from FIG. 2, the front sidewall 37 of the safety dock body terminates in a curved lip portion 49 which extends substantially the length “1” of the front sidewall 37 and which sized to curve around and over the gutter front lip 29 (see FIG. 4) to help secure the ladder safety dock body in place within the gutter open interior space 33 while also presenting a pleasing esthetic profile as viewed from the front side of the gutter and the street.

As will be seen in FIGS. 1, 3, and 4, the oppositely arranged retaining ears 45, 47 are formed as an extension of the safety dock body opposing end walls 41, 43 so that the retaining ears 45, 47 lie in a common plane with the dock body end walls. As shown in FIG. 2, the oppositely arranged retaining ears 45, 47 are preferably formed as planar flaps, each having an opening 51, 53 formed therein for receiving a safety line for securing the ladder 11 in position between the retaining ears.

The safety line can comprise any convenient means of tie-down for the ladder 11. For example, the safety line can comprise a rope, but preferably comprises a bungee cord formed of a length of elastic material and having hooks at either end thereof which can be engaged with the openings 51, 53. In this way, the bungee cord elastic portion can be passed over the ladder runners 13, 15 and help to secure the ladder in position. A portion of a typical commercially available bungee cord 48 is shown in FIG. 6. It is an elastic cord composed of one or more elastic strands forming a core, covered in a woven sheath, usually of nylon or cotton.

As shown in FIGS. 2 and 4, the ladder safety dock of the invention can also be provided with a grated opening 55, 57 formed in each of the two opposing end walls 43, 45 of the dock body. The grated openings 55, 57 serve as a pre-filter which can be used to strain leaves and other debris from the water flowing through the gutter to the down spout. By using the ladder dock as a pre-filter element, there is less chance of the down spout becoming clogged. The particular size openings of the grate material are not critical as long as fluid can freely flow and leaves and other larger debris are trapped.

As shown in FIG. 2, a plurality of holes 59, 61 are pre-drilled in the rear sidewall 39 of the safety dock body to accommodate suitable attachment elements for securing the safety dock body to the back side 23 (FIG. 1) of the gutter and, in turn, to the underlying fascia board or rafters of the building structure. The attachment elements can be, for example, wood screws, nails, or the like.

As will be appreciated from FIG. 4, the ladder safety dock sidewalls 37, 39 and end walls 41, 43 are of a predetermined height “h” which is selected to allow the safety dock to fit closely within the gutter interior space in flush fashion, whereby the safety dock curved lip 49 and retaining ears 45, 47 are the only portions of the safety dock readily visible by an observer on the ground. The curved lip 49 thus serves the dual purposes of supporting the safety dock upon the lip 29 of the gutter while at the same time presenting a smooth, contoured surface which helps to hide the remainder of the dock body and present an esthetically pleasing appearance.

In use, the ladder dock body shown in FIG. 2 is simply placed within the open interior space of the gutter as shown in FIGS. 3 and 4. The body is pre-sized to fit the rough contours of the gutter interior space so that the curved lip portion 49 curves over the gutter front lip 29 with the height “h” of the rear wall 39 being approximately the same as the back sidewall 23 of the gutter without protruding above. The ladder dock is secured in position by passing wood screws or nails through the openings 59 provided in the rear sidewall 39 thereof.

The ladder dock thus secured allows the ladder rails 13, 15 to be snugly received between the retaining ears 45, 47 and prevents any sidewise motion of the ladder 11. A bungee cord or other safety line can be passed through the openings 51, 53 of the retaining ears 45, 47 to further secure the ladder and prevent a user from falling backwards from the wall of the building.

An invention has been provided with several advantages. The ladder safety dock of the invention is simple in design and economical to manufacture. It can conveniently be formed from such commonly available materials as aluminum, rigid plastics and composites. The preferred material is an all aluminum construction. The safety dock can be easily attached to the gutter in only a short amount of time and then provides a secure environment for a user when accessing the building roof. The ears of the safety dock protrude slightly above the remainder of the body of the device and can serve as “locating elements” for a user on the ground in determining the position of the safety device for mounting the ladder. Thus, the safety dock of the invention may be easily enough removed and transferred from one building to another or one location to another, but may also be left permanently or semi-permanently in place. The design of the sidewalls of the device and curved front lip make it an unobtrusive device in appearance when installed so that the esthetics of the building roof line are not interrupted.

While the invention has been shown in only one of its forms, it is not thus limited but is susceptible to various changes and modifications without departing from the spirit thereof.

What is claimed is:

1. A ladder safety dock for supporting a ladder on a fascia board or rafters of the roof of a building structure having a gutter where the gutter has a back sidewall adapted to be fastened to the fascia board or rafters, an opposing front sidewall with a front sidewall lip, a bottom wall, and an open top, the ladder safety dock comprising:
a dock body installable within the gutter in a longitudinal plane substantially adjacent the open top of said gutter, the dock body having a front sidewall of a given length, a rear sidewall and opposing end walls, the dock body also having a pair of oppositely arranged retaining ears extending outwardly at either of two opposite extents thereof, the retaining ears being spaced apart a predetermined distance to allow a ladder to be received there between to thereby prevent the ladder from sliding along the gutter;
wherein the front sidewall of the safety dock body terminates in a curved lip portion which extends substantially the length of the front sidewall and which is sized to curve around and over the gutter front lip to help to secure the dock body in place within the gutter while also presenting a pleasing esthetic profile as viewed from the front sidewall of the gutter.

2. The ladder safety dock of claim 1, wherein the oppositely arranged retaining ears are formed as an extension of the dock body opposing end walls so that the retaining ears lie in a common plane with the dock body end walls.

3. The ladder safety dock of claim 2, wherein the retaining ears are planar flaps, each having an opening formed therein for receiving a safety line for securing a ladder in position between the retaining ears.

4. The ladder safety dock of claim 3, wherein the safety line is a bungee cord formed of a length of an elastic material and having hooks at either of two ends thereof.

5. The ladder safety dock of claim 1, further comprising:
a grated opening formed in each of the two opposing end walls of the safety dock body, the grated opening being sized to allow fluids to flow but to arrest the movement of trash and other debris.

6. The ladder safety dock of claim 1, wherein a plurality of holes are pre-drilled in the rear sidewall of the safety dock body to accommodate attachment elements for securing the safety dock body to the rear sidewall and, in turn, the gutter and fascia board or rafter of the building structure.

7. The ladder safety dock of claim 1, wherein the ladder safety dock body sidewalls and end walls are of a predetermined height which is selected to allow the safety dock to fit closely within the gutter in substantially flush fashion, whereby the safety dock curved lip and retaining ears are the only portions of the safety dock readily visible by an observer on the ground.

8. The ladder safety dock of claim 1, wherein the safety dock body is formed of a material selected from the group consisting of aluminum, rigid plastics and composites.

9. The ladder safety dock of claim 6, wherein the safety dock body is attached to the gutter by the attachment elements and the dock body is left in position within the gutter permanently at a desired convenient location for future use.

10. The ladder safety dock of claim 9, wherein at least the curved lip portion and retaining ears of the ladder safety dock are painted to match the gutter, thereby further minimizing any obtrusive aspect of the design.

11. A ladder safety dock for supporting a ladder on a fascia board or rafters of the roof of a building structure having a gutter of a given length, where the gutter has a back sidewall adapted to be fastened to the fascia board or rafters, an opposing front sidewall with a front sidewall lip, a bottom wall, and an open top and an interior space, the ladder safety dock comprising:
a dock body installable within the gutter interior space in a longitudinal plane substantially adjacent the open top of said gutter, the dock body having a front sidewall of a given length, a rear sidewall and opposing end walls, the dock body also having a pair of oppositely arranged retaining ears extending outwardly at either of two opposite extents thereof, the retaining ears being spaced apart a predetermined distance to allow a ladder to be received there between in snug fashion to thereby prevent the ladder from sliding along the gutter, the oppositely arranged retaining ears constituting planar flaps which are formed as an extension of the dock body opposing end walls so that the retaining ears lie in a common plane with the dock body end walls, each retaining ear having an elongate opening formed therein for receiving an end hook of a bungee cord for securing a ladder in position against the safety dock and in position between the retaining ears;
wherein the front sidewall of the safety dock body terminates in a curved lip portion which extends substantially the length of the front sidewall and which is sized to curve around and over the gutter front lip to help to secure the dock body in place within the gutter by supporting it on the front sidewall of the gutter while also presenting a pleasing esthetic profile as viewed from the front sidewall of the gutter;
wherein a plurality of holes are pre-drilled in the rear sidewall of the safety dock body to accommodate attachment elements for securing the safety dock body to the rear sidewall and, in turn, to the gutter and fascia board or rafters of the building structure; and
wherein the ladder safety dock body sidewalls and end walls are of a predetermined height which is selected to allow the safety dock to fit within the gutter in substantially flush fashion with only the retaining ears protruding upwardly above the gutter, whereby the safety dock curved lip and retaining ears are the only portions of the safety dock readily visible by an observer on the ground.
